(19) United States
(12) Patent Application Publication
(10) Pub. No.: US 2006/0009089 A1
(43) Pub. Date: Jan. 12, 2006

(54) Safety electrical connection assembly for appliances

(76) Inventor: James Taylor Lloyd, New York, NY (US)

Correspondence Address: STEVEN A. GARNER;CONAIR CORPORATION, ONE CUMMINGS POINT ROAD, STAMFORD, CT, 06902, US

(21) Appl. No.: 11/178,921

(22) Filed: Jul. 11, 2005

Related U.S. Application Data
(60) Provisional application No. 60/586,961, filed on Jul. 9, 2004.

(51) Int. Cl. H01R 12/00

(52) U.S. Cl. 439/825

(57) ABSTRACT

An electrical connection assembly enables selective contact between terminal ends and appliance conductors while preventing inadvertent contact with terminal ends when not in use, wherein the need for complex or moveable parts is eliminated. Terminal ends are sunk into openings in a base such that they cannot be contacted by any person or object larger than the openings into which they are sunk. A set of spring leafs is arranged to form each terminal. The appliance conductor pins are shaped and sized to enter the openings into which the terminal ends are sunk, and to simultaneously block access to the openings by any other objects. The pins enter into and are held by the leaf springs, which surround the pin in a flower-petal configuration.

### CROSS-REFERENCE TO RELATED APPLICATIONS

This application claims priority to U.S. Provisional Patent Application Ser. No. 60/586,961 filed on Jul. 9, 2004, incorporated herein by reference in its entirety.

### BACKGROUND OF THE INVENTION

1. Field of the Invention

The present invention relates to electrical connection assemblies and, more particularly, to electrical connection assemblies that enable selective contact between terminal ends and appliance conductors while preventing inadvertent contact with terminal ends when not in use.

2. Description of Related Art

Various electrical appliances exist in which it is desirable to allow one or more parts to be removed from a base, in which the base conducts electrical energy from an external power source and transfers the energy to the removable part. For example, certain cooking appliances have an electrical base with a removable pot or griddle, wherein the pot or griddle has conductive pins that, when in conductive contact with the base, provide electrical energy to on-board heat elements.

Known devices achieve this result by providing a movable cover on the base, whereby the cover selectively slides over the terminal ends on the base to protect them while the removable part is disengaged. When the removable part is engaged, one or more mechanisms cause the cover to be slid away from the terminal ends to expose them and allow them to contact the appliance conductor pins.

### OBJECT AND SUMMARY OF THE INVENTION

It is an object of the present invention to overcome the shortcomings of the prior art mentioned above. These and other objects are achieved by the present invention described herein.

It is desirable to provide an electrical connection assembly that enables selective contact between terminal ends and appliance conductors while preventing inadvertent contact with terminal ends when not in use, wherein the need for complex or moveable parts is eliminated. The elimination of such parts eliminates potential wear, costs, and complexity in assembly. Furthermore, safety is enhanced because potential of failure is eliminated.

The present invention achieves these and other objectives by provided terminal ends that are sunk into openings in a base such that they cannot be contacted by any person or object larger than the openings into which they are sunk. In order to provide positive contact and resistance to pull-out, a novel spring leaf design is employed. The appliance conductor pins are shaped and sized to enter the openings into which the terminal ends are sunk, and to simultaneously block access to the openings by any other objects. The pins enter into and are held by the leaf springs, which surround the pin in a flower-petal configuration.

### BRIEF DESCRIPTION OF THE DRAWINGS

The present invention is more fully understood by reference to the following detailed description of an illustrative embodiment with the drawings identified below.

FIG. 1 is a top view of a connector block according to the present invention.

FIG. 2 is a side, sectional view of the connector assembly according to the present invention.

FIG. 3 is a side, sectional view of the connector assembly according to the present invention.

### DETAILED DESCRIPTION OF THE INVENTION

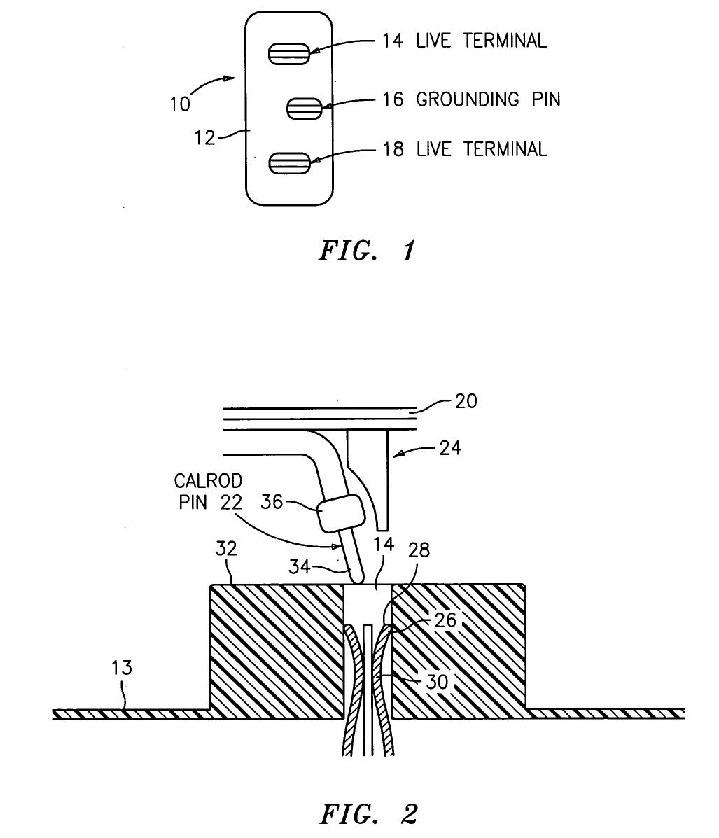

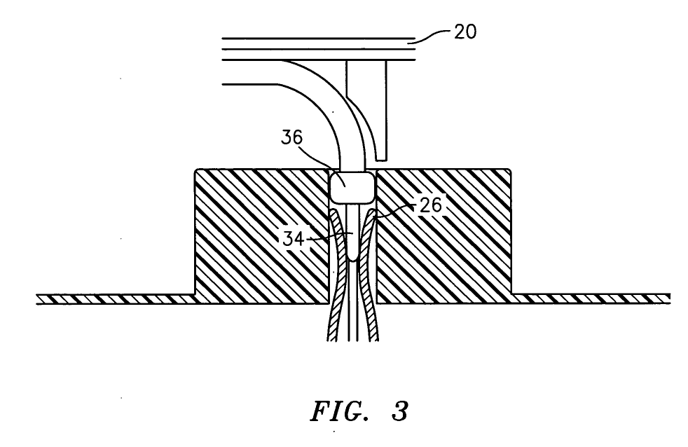

Referring to FIGS. 1 and 2, an electrical appliance contains a connector block 10, which can be permanently attached to the base of the electrical appliance. The connector block 10 comprises a body 12 adapted to be attached to an electrical appliance base 13. The block 10 includes openings 14, 16, 18. Opening 16 is adapted to receive a grounding pin 24, which can be attached to a removable portion 20 of an electrical appliance. Openings 14, 18 receive two live conductor pins 22 of a removable portion 20 of an electrical appliance. The conductor pins 22 can be of various types, such as calrod pins. The openings 14, 18 for the conductor pins are identical and, thus, only one is illustrated in FIGS. 2-3, and only one is discussed below.

FIG. 2 shows the electrical connection assembly in its “disassembled” state. FIG. 3 illustrates the assembly in its “assembled” state. The opening 14 in the connector block 10 contains a live electrical terminal end. This live electrical terminal end can be in the configuration of four spring-biased contacts 26. In a preferred embodiment, these spring-biased contacts are leaf springs, in a “cauliflower” type arrangement. This leaf spring design provides positive contact and resistance to pull-out.

Each leaf spring 26 has a distal tip 28 and a curved mid-portion 30. The distal tips 28 are distanced from the edge of the opening 14 at a sufficient distance from the top surface 32 of the block 10 to prevent inadvertent contact with the leaf springs 26. The diameter of the block opening 14 would preferably be small enough to prevent an operator's fingers from entering the opening 14.

When the removable part is positioned over the base 13 for operation, the conductor pins 22 enter the opening 14 and the pin ends 34 are received between the springs 26, which flex and make contact along the curved mid-portions 30, as shown in FIG. 3. The four leaf-shaped connectors, which are biased inward, ensure a tight fit between the conductor pins 22 and the live terminals 26. The grounding pin 24 enters the block opening 16.

In order to further prevent an operator's fingers or other objects from entering the live electrical terminal end opening 14, a collar 36 is utilized. The collar 36 is positioned on the conductor pins to fill the openings 14 when the pin ends 34 are engaged with the springs 26. The collar 36 is located at a distance from the pin end 34 and preferably has a diameter slightly smaller than that of the opening 14. This slightly smaller diameter will prevent objects from entering the opening 14.

The present invention assembly is suitable for use with a variety of appliances including, but not limited to, fryers, fry pans, kettles and griddles for consumer use.

While a preferred embodiment of the invention has been herein disclosed and described, it is understood that various modifications can be made without departing from the scope of the invention.

What is claimed is:

1. An electrical connection assembly for an appliance comprising:
a first portion selectively removable from said appliance;
a second portion protruding from a base of said appliance, said second portion having a first hole and a second hole;
a plurality of live electrical terminal ends within said first hole; and
a conductor pin on said first portion adapted to be received within said first hole to contact said plurality of live electrical terminal ends.

2. An electrical connection assembly according to claim 1, further comprising
a grounding pin on said first portion adapted to be received within said second hole.

3. An electrical connection assembly according to claim 1, wherein
said plurality of live electrical terminal ends are spring biased contacts.

4. An electrical connection assembly according to claim 1, wherein
said plurality of live electrical terminal ends are leaf springs biased toward a central axis and adapted to flex and hold said conductor pin as said conductor pin is received between said plurality of live electrical terminal ends.

5. An electrical connection assembly according to claim 1, wherein
said conductor pin further comprises a collar to fill said first hole when said conductor pin is in contact with said plurality of live electrical terminal ends, said collar having a diameter slightly smaller than the diameter of said first hole.

6. An electrical connection assembly according to claim 1, wherein
said plurality of live electrical terminal ends are sunk in said first hole.

7. An electrical connection assembly according to claim 5, wherein
said plurality of live electrical terminal ends are distanced from the edge of the opening of said first hole to prevent inadvertent contact with said plurality of live electrical terminal ends.

8. An electrical connection assembly according to claim 1, wherein
said first hole has a diameter to prevent an operator's fingers from contacting said plurality of live electrical terminal ends.

9. An electrical connection assembly according to claim 4, wherein
said leaf springs have a distal tip and a curved mid-portion.

10. An electrical connection assembly according to claim 1, wherein
said second portion is a block.
